(19) United States
(12) Patent Application Publication
(10) Pub. No.: US 2013/0087948 A1
(43) Pub. Date: Apr. 11, 2013

(54) ABLATION METHOD FOR SUBSTRATE ON WHICH PASSIVATION FILM IS FORMED

(71) Applicant: Disco Corporation, Tokyo (JP)

(72) Inventor: Nobuyasu KITAHARA, Tokyo (JP)

(73) Assignee: DISCO CORPORATION, Tokyo (JP)

(21) Appl. No.: 13/644,988

(22) Filed: Oct. 4, 2012

(30) Foreign Application Priority Data
Oct. 6, 2011 (JP) 2011-221721

(51) Int. Cl. B29C 35/08

(52) U.S. Cl. 264/400

(57) ABSTRACT

An ablation method of applying a laser beam to a substrate on which a passivation film of nitride is formed, thereby performing ablation. The ablation method includes a protective film forming step of applying a liquid resin containing a fine powder of oxide having absorptivity to the wavelength of the laser beam to at least a subject area of the substrate to be ablated, thereby forming a protective film containing the fine powder on at least the subject area of the substrate, and a laser processing step of applying the laser beam to the subject area coated with the protective film, thereby performing ablation through the protective film to the subject area of the substrate after performing the protective film forming step.

### BACKGROUND OF THE INVENTION

1. Field of the Invention

The present invention relates to an ablation method of applying a laser beam to a substrate on which a passivation film of nitride is formed, thereby performing ablation.

2. Description of the Related Art

A plurality of devices such as ICs, LSIs, and LEDs are formed on the front side of a wafer such as a silicon wafer and a sapphire wafer so as to be partitioned by a plurality of division lines. The wafer is divided into the individual devices by any dividing apparatus such as a cutting apparatus and a laser processing apparatus. These devices are widely used in various electrical equipment such as mobile phones and personal computers. As a method of dividing the wafer into the individual devices, a dicing method using a cutting apparatus called a dicing saw is widely adopted. In this dicing method, a cutting blade having a thickness of about 30 μm is rotated at a high speed of about 30000 rpm and fed in the wafer to cut the wafer, thus dividing the wafer into the individual devices. The cutting blade is formed by bonding abrasive grains of diamond, for example, with metal or resin.

On the other hand, there has recently been proposed another dividing method including the steps of applying a pulsed laser beam having an absorption wavelength to the wafer to thereby form a plurality of laser processed grooves by ablation and next breaking the wafer along the laser processed grooves by using a breaking apparatus, thus dividing the wafer into the individual devices (see Japanese Patent Laid-open No. Hei 10-305420, for example). This ablation method for forming the laser processed grooves has an advantage over the dicing method using a dicing saw in that the processing speed is higher and a wafer formed of a hard material such as sapphire and SiC can also be processed relatively easily. Furthermore, the width of each laser processed groove can be reduced to 10 μm or less, so that the number of devices obtainable per wafer can be increased as compared with the dicing method.

### SUMMARY OF THE INVENTION

When a pulsed laser beam having an absorption wavelength (e.g., 355 nm) to a semiconductor substrate as the wafer, the energy of the laser beam absorbed by the semiconductor substrate reaches a bandgap energy to break the atomic bond in the semiconductor substrate, thereby performing the ablation. However, in the case that a passivation film of nitride such as Si₃N₄ is formed on the front side of the semiconductor substrate, there is a problem such that the scattering of the energy of the laser beam and the reflection of the laser beam may occur, so that the energy of the laser beam may not be sufficiently used for the ablation to cause a large energy loss. Further, there is another problem such that the laser beam passed through the passivation film may ablate the semiconductor substrate and break the passivation film from the inside surface thereof.

It is therefore an object of the present invention to provide an ablation method which can suppress the scattering of the energy and the reflection of the laser beam in ablating a substrate on which a passivation film is formed.

In accordance with an aspect of the present invention, there is provided an ablation method of applying a laser beam to a substrate on which a passivation film of nitride is formed, thereby performing ablation, the ablation method including a protective film forming step of applying a liquid resin containing a fine powder of oxide having absorptivity to the wavelength of the laser beam to at least a subject area of the substrate to be ablated, thereby forming a protective film containing the fine powder on at least the subject area of the substrate; and a laser processing step of applying the laser beam to the subject area coated with the protective film, thereby performing ablation through the protective film to the subject area of the substrate after performing the protective film forming step.

Preferably, the fine powder of the oxide has an average particle size smaller than the spot diameter of the laser beam. Preferably, the wavelength of the laser beam is 355 nm or less; the fine powder of the oxide includes a metal oxide selected from the group consisting of Fe₂O₃, ZnO, TiO₂, CeO₂, CuO, Cu₂O, and MgO; and the liquid resin includes polyvinyl alcohol.

According to the ablation method of the present invention, the liquid resin containing the fine powder of oxide having absorptivity to the wavelength of the laser beam is first applied to at least the subject area of the substrate to be ablated, thereby forming the protective film containing the fine powder of oxide. Thereafter, the ablation is performed through the protective film to the subject area of the substrate. Accordingly, the energy of the laser beam is absorbed by the fine powder of oxide contained in the protective film to reach a bandgap energy and break the atomic bond, thereby causing chained ablation to the passivation film. As a result, the scattering of the energy and the reflection of the laser beam can be suppressed to thereby efficiently and smoothly perform the ablation of the substrate on which the passivation film is formed.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a schematic perspective view of s laser processing apparatus for performing the ablation method according to the present invention;

FIG. 2 is a block diagram of a laser beam applying unit;

FIG. 3 is a perspective view of a semiconductor wafer supported through an adhesive tape to an annular frame;

FIG. 4 is a sectional view of the semiconductor wafer on which a passivation film of nitride is formed;

FIG. 5 is a perspective view showing a liquid resin applying step;

FIG. 6 is a graph showing the spectral transmittance of various metal oxides;

FIG. 7 is a perspective view showing a laser processing step by ablation; and

FIG. 8 is a perspective view similar to FIG. 3, showing a condition that the ablation has been finished.

### DETAILED DESCRIPTION OF THE PREFERRED EMBODIMENT

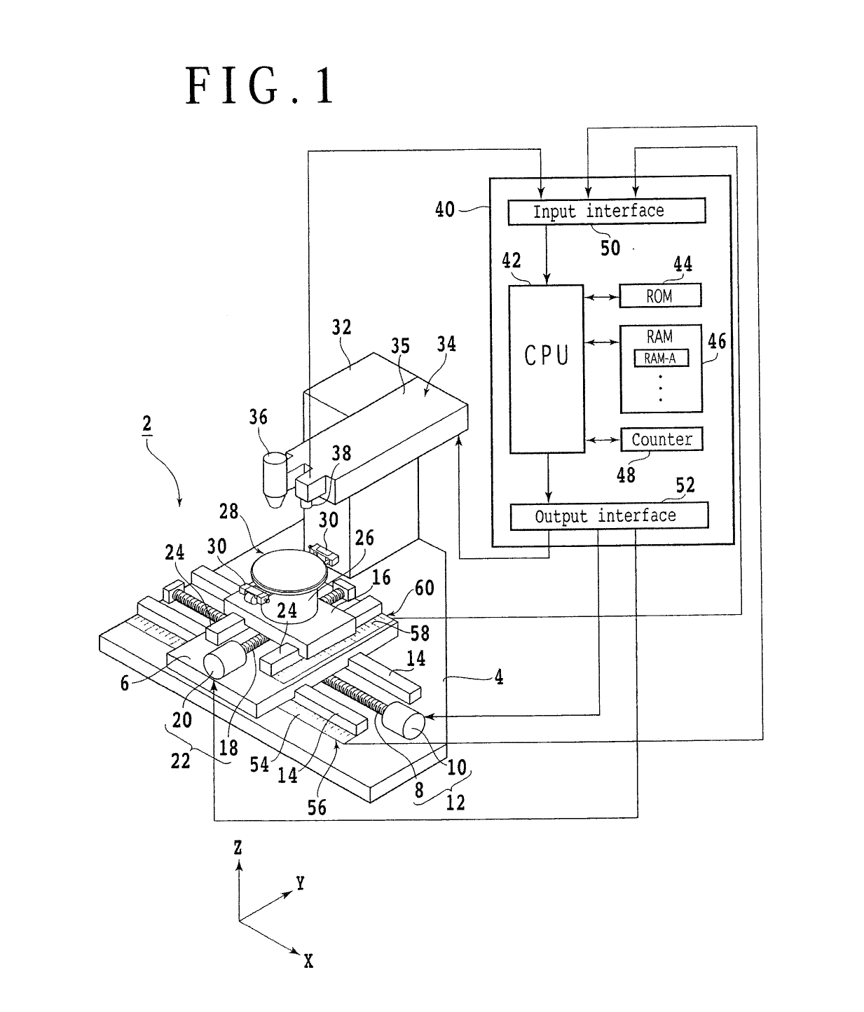

A preferred embodiment of the present invention will now be described in detail with reference to the drawings. FIG. 1 is a schematic perspective view of a laser processing apparatus 2 for performing the ablation method according to the present invention for ablating a substrate on which a passivation film is formed. The laser processing apparatus 2 includes a stationary base 4 and a first slide block 6 supported to the stationary base 4 so as to be movable in the X direction shown by an arrow X. The first slide block 6 is movable in a feeding direction, i.e., in the X direction along a pair of guide rails 14 by feeding means 12 including a ball screw 8 and a pulse motor 10.

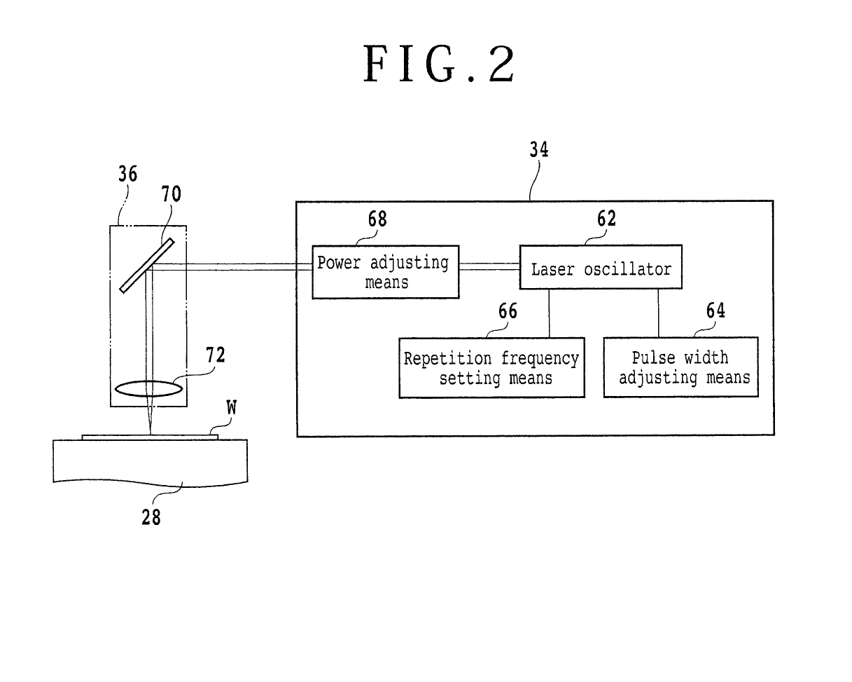

A second slide block 16 is supported to the first slide block 6 so as to be movable in the Y direction shown by an arrow Y. The second slide block 16 is movable in an indexing direction, i.e., in the Y direction along a pair of guide rails 24 by indexing means 22 including a ball screw 18 and a pulse motor 20. A chuck table 28 is supported through a cylindrical support member 26 to the second slide block 16. Accordingly, the chuck table 28 is movable both in the X direction and in the Y direction by the feeding means 12 and the indexing means 22. The chuck table 28 is provided with a pair of clamps 30 for clamping a semiconductor wafer W (see FIG. 2) held on the chuck table 28 under suction.

A column 32 is provided on the stationary base 4, and a casing 35 for accommodating a laser beam applying unit 34 is mounted on the column 32. As shown in FIG. 2, the laser beam applying unit 34 includes a laser oscillator 62 such as a YAG laser oscillator or a YVO4 laser oscillator, repetition frequency setting means 64, pulse width adjusting means 66, and power adjusting means 68. A pulsed laser beam is generated by the laser oscillator 62, and the power of the pulsed laser beam is adjusted by the power adjusting means 68. Focusing means 36 is mounted at the front end of the casing 35 and includes a mirror 70 and a focusing objective lens 72. The pulsed laser beam from the laser beam applying unit 34 is reflected by the mirror 70 and next focused by the objective lens 72 in the focusing means 36 so as to form a laser beam spot on the front side of the semiconductor wafer W held on the chuck table 28.

Referring back to FIG. 1, an imaging unit 38 for detecting a subject area of the semiconductor wafer W to be laser-processed is also provided at the front end of the casing 35 so as to be juxtaposed to the focusing means 36 in the X direction. The imaging unit 38 includes an ordinary imaging device such as a CCD for imaging the subject area of the semiconductor wafer W by using visible light. The imaging unit 38 further includes an infrared imaging unit composed of infrared light applying means for applying infrared light to the semiconductor wafer W, an optical system for capturing the infrared light applied to the semiconductor wafer W by the infrared light applying means, and an infrared imaging device such as an infrared CCD for outputting an electrical signal corresponding to the infrared light captured by the optical system. An image signal output from the imaging unit 38 is transmitted to a controller (control means) 40.

The controller 40 is configured by a computer, and it includes a central processing unit (CPU) 42 for performing operational processing according to a control program, a read only memory (ROM) 44 preliminarily storing the control program, a readable and writable random access memory (RAM) 46 for storing the results of computation, etc., a counter 48, an input interface 50, and an output interface 52. Reference numeral 56 denotes feed amount detecting means including a linear scale 54 provided along one of the guide rails 14 and a read head (not shown) provided on the first slide block 6. A detection signal from the feed amount detecting means 56 is input into the input interface 50 of the controller 40.

Reference numeral 60 denotes index amount detecting means including a linear scale 58 provided along one of the guide rails 24 and a read head (not shown) provided on the second slide block 16. A detection signal from the index amount detecting means 60 is input into the input interface 50 of the controller 40. An image signal from the imaging unit 38 is also input into the input interface 50 of the controller 40. On the other hand, control signals are output from the output interface 52 of the controller 40 to the pulse motor 10, the pulse motor 20, and the laser beam applying unit 34.

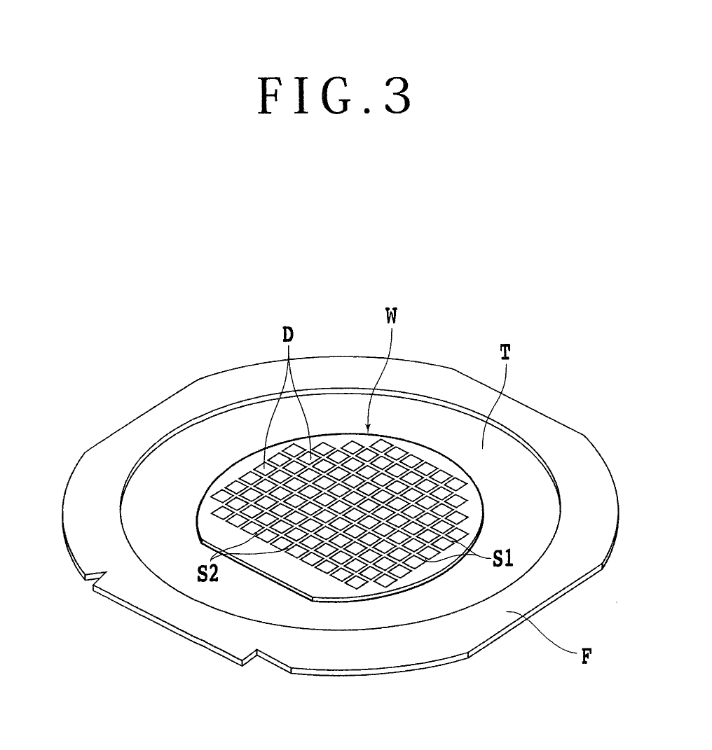

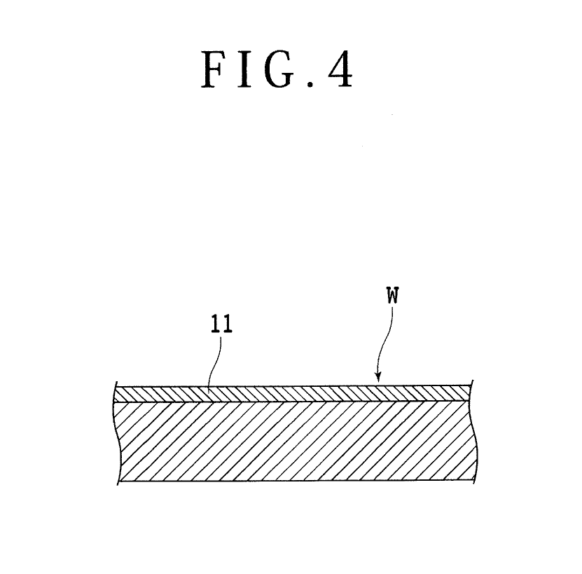

As shown in FIG. 3, a plurality of first streets S1 and a plurality of second streets S2 perpendicular to the first streets S1 are formed on the front side of the semiconductor wafer (semiconductor substrate) W as a workpiece to be processed by the laser processing apparatus 2, thereby partitioning a plurality of rectangular regions where a plurality of devices D are respectively formed. Further, as best shown in FIG. 4, a passivation film 11 of nitride is formed on the front side (device surface) of the semiconductor wafer W. More specifically, the passivation film 11 is formed of silicon nitride such as Si₃N₄ and SiN (SiₓN_{y}).

The wafer W is attached to a dicing tape T as an adhesive tape whose peripheral portion is preliminarily attached to an annular frame F. Accordingly, the wafer W is supported through the dicing tape T to the annular frame F. The wafer W is held through the dicing tape T on the chuck table 28 under suction, and the annular frame F is fixed by the clamps 30 shown in FIG. 1. Thus, the wafer W supported through the dicing tape T to the annular frame F is fixedly held on the chuck table 28 in the condition where the front side of the wafer W is oriented upward.

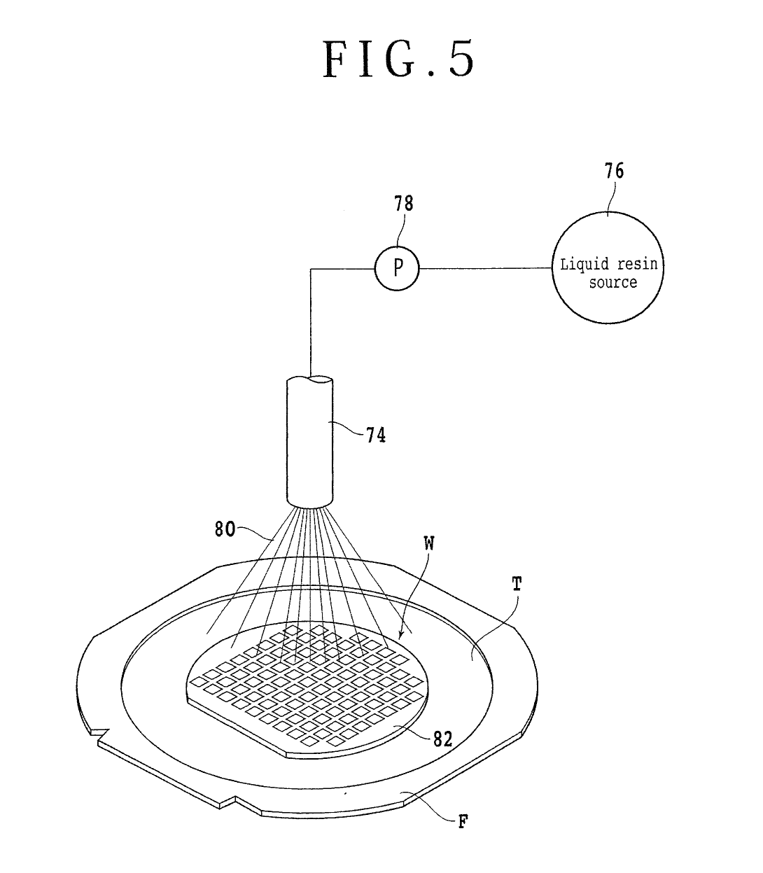

In the ablation method of the present invention, a liquid resin applying step is performed in such a manner that a liquid resin containing a fine powder of oxide having absorptivity to the wavelength of the laser beam is applied to the subject area of the semiconductor wafer (semiconductor substrate) W to be ablated. For example, as shown in FIG. 5, a liquid resin 80 such as PVA (polyvinyl alcohol) containing a fine powder of oxide (e.g., TiO₂) having absorptivity to the wavelength (e.g., 355 nm) of the laser beam is stored in a liquid resin source 76.

A pump 78 is connected to the liquid resin source 76, and a nozzle 74 is connected to the pump 78. Accordingly, when the pump 78 is driven, the liquid resin 80 stored in the liquid resin source 76 is supplied from the nozzle 74 to the front side of the wafer W and then applied thereto. Thereafter, the liquid resin 80 applied to the front side of the wafer W is cured to form a protective film 82 containing the fine powder of oxide having absorptivity to the wavelength of the laser beam. As a method of applying the liquid resin 80 to the front side of the wafer W, spin coating may be adopted to apply the liquid resin 80 as rotating the wafer W. In this preferred embodiment, TiO₂ is adopted as the fine powder of oxide mixed in the liquid resin 80 such as PVA (polyvinyl alcohol) and PEG (polyethylene glycol).

While the liquid resin 80 containing the fine powder of oxide is applied to the entire surface of the front side of the wafer W to form the protective film 82 in this preferred embodiment shown in FIG. 5, the liquid resin 80 may be applied to only the subject area to be ablated, i.e., the first streets S1 and the second streets S2. In this preferred embodiment, the semiconductor wafer W is formed from a silicon wafer. The absorption edge wavelength of silicon is 1100 nm, so that ablation of the wafer W can be smoothly performed by using the laser beam having a wavelength of 355 nm or less. The average particle size of the fine powder of oxide mixed in the liquid resin 80 is preferably smaller than the spot diameter of the laser beam, more specifically smaller than 10 μm, for example.

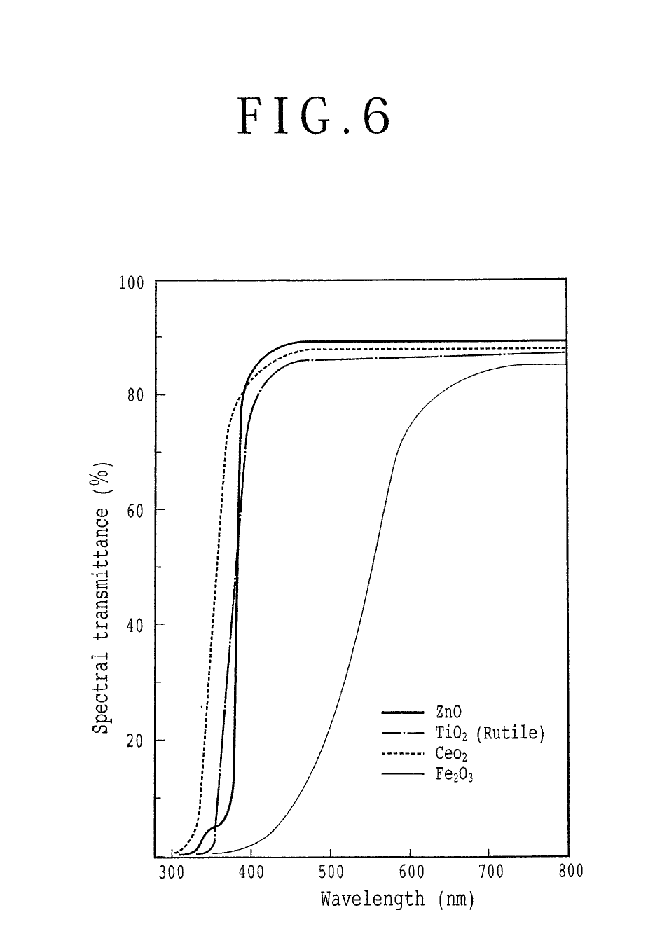

Referring to FIG. 6, there is shown the relation between spectral transmittance and wavelength for various metal oxides, i.e., ZnO, TiO₂, CeO₂, and Fe₂O₃. It can be understood from the graph shown in FIG. 6 that the laser beam to be used for ablation is almost absorbed by the fine powder of these metal oxides by setting the wavelength of the laser beam to 355 nm or less. As other metal oxides not shown in FIG. 6, CuO, Cu₂O, and MgO have a similar tendency on spectral transmittance. Accordingly, CuO, Cu₂O, and MgO may also be adopted as the fine powder of oxide mixed in the liquid resin in the present invention. Thus, any one of TiO₂, Fe₂O₃, ZnO, CeO₂, CuO, Cu₂O, and MgO may be adopted as the fine powder of oxide mixed in the liquid resin in the present invention.

Table 1 shows the extinction coefficients k and melting points of these metal oxides. There is a relation of α=4 πk/A between extinction coefficient k and absorption coefficient α, where λ is the wavelength of light to be used.

TABLE 1

| | Extinction coefficient | Melting |
|---|---|---|
| | k (@355 nm) | point (° C.) |
| ZnO | 0.38 | 1975 |
| TiO₂ | 0.2 | 1870 |
| Fe₂O₃ | 1< | 1566 |
| CeO₂ | 0.2 | 1950 |
| CuO | 1.5 | 1201 |
| Cu₂O | 1.44 | 1235 |

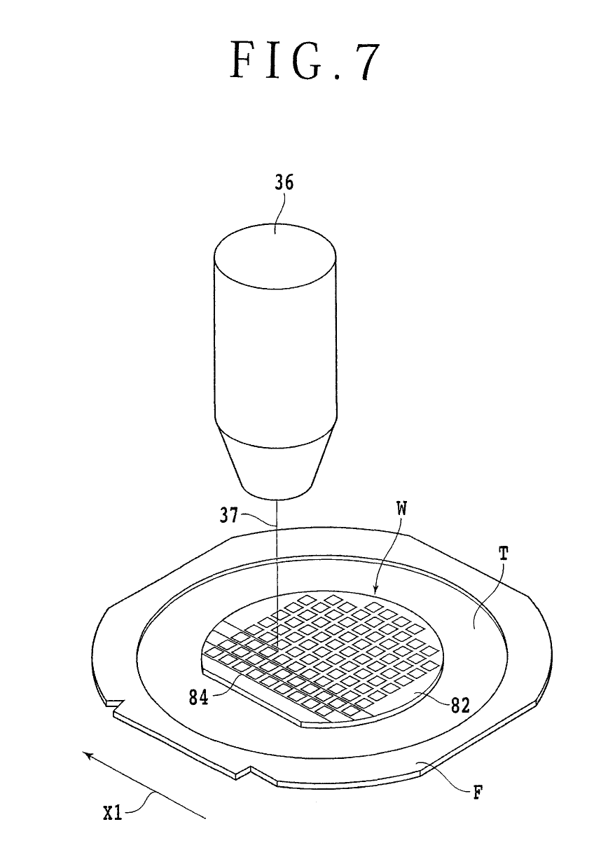

After performing the liquid resin applying step to form the protective film 82 on the front side of the wafer W, a laser processing step by ablation is performed. This laser processing step is performed as shown in FIG. 7 in such a manner that a pulsed laser beam 37 having an absorption wavelength (e.g., 355 nm) to the semiconductor wafer W and the fine powder of oxide contained in the protective film 82 is focused by the focusing means 36 and applied to the front side of the semiconductor wafer W. At the same time, the chuck table 28 holding the semiconductor wafer W supported through the dicing tape T to the annular frame F is moved at a predetermined feed speed in the direction shown by an arrow X1 in FIG. 7 to thereby form a laser processed groove 84 on the front side of the wafer W along a predetermined one of the first streets S1 by ablation.

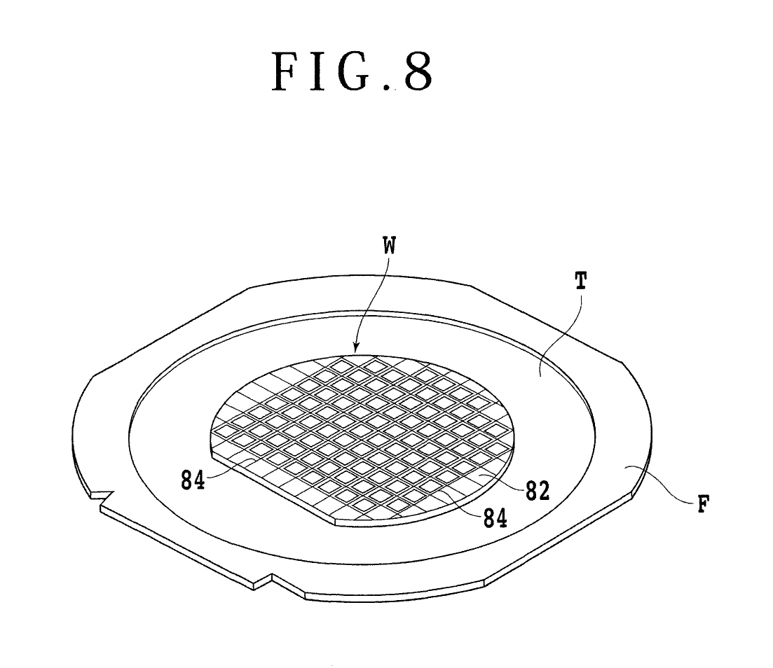

Thereafter, the chuck table 28 holding the wafer W is indexed in the Y direction to similarly perform the ablation along all of the first streets S1, thereby forming a plurality of laser processed grooves 84 on the front side of the wafer W along all of the first streets Si. Thereafter, the chuck table 28 is rotated 90° to similarly perform the ablation along all of the second streets S2 perpendicular to the first streets S1, thereby forming a plurality of laser processed grooves 84 on the front side of the wafer W along all of the second streets S2. FIG. 8 is a perspective view showing the condition where the laser processed grooves 84 have been formed along all of the first and second streets S1 and S2.

This laser processing is performed under the following conditions, for example.

| | |
|---|---|
| Light source | YAG pulsed laser |
| Wavelength | 355 nm (third harmonic generation |
| | of YAG laser) |
| Average power | 0.5 to 10 W |
| Repetition frequency | 10 to 200 kHz |
| Spot diameter | φ1 to 10 μm |
| Feed speed | 10 to 100 mm/sec |

Examples of the substrate applicable in the present invention may include Si, SiGe, Ge, AlN, InAlN, InN, GaN, InGaN, SiC, and GaAs substrates.

According to the ablation method of this preferred embodiment, the liquid resin 80 containing the fine powder of oxide having absorptivity to the wavelength of the laser beam is first applied to the front side of the wafer W to form the protective film 82. Thereafter, the ablation is performed through the protective film 82 to the front side of the wafer W. Accordingly, the energy of the laser beam is absorbed by the fine powder of oxide contained in the protective film 82 to reach a bandgap energy and break the atomic bond, thereby causing chained ablation to the passivation film 11.

As a result, the scattering of the energy and the reflection of the laser beam can be suppressed to thereby perform the ablation efficiently and smoothly. The fine powder of oxide mixed in the liquid resin functions as a processing accelerator. After forming the laser processed grooves 84 along all of the streets S1 and S2, the dicing tape T is radially expanded by using a breaking apparatus well known in the art to thereby apply an external force to the wafer W. As a result, the wafer W is divided along the laser processed grooves 84 by this external force to obtain the individual devices D.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. An ablation method of applying a laser beam to a substrate on which a passivation film of nitride is formed, thereby performing ablation, said ablation method comprising:
a protective film forming step of applying a liquid resin containing a fine powder of oxide having absorptivity to the wavelength of said laser beam to at least a subject area of said substrate to be ablated, thereby forming a protective film containing said fine powder on at least said subject area of said substrate; and
a laser processing step of applying said laser beam to said subject area coated with said protective film, thereby performing ablation through said protective film to said subject area of said substrate after performing said protective film forming step.

2. The ablation method according to claim 1, wherein said fine powder of said oxide has an average particle size smaller than a spot diameter of said laser beam.

3. The ablation method according to claim 1, wherein
the wavelength of said laser beam is 355 nm or less;
said fine powder of said oxide includes a metal oxide selected from the group consisting of Fe₂O₃, ZnO, TiO₂, CeO₂, CuO, Cu₂O, and MgO; and
said liquid resin includes polyvinyl alcohol.
